(19) United States
(12) Patent Application Publication
(10) Pub. No.: US 2018/0150080 A1
(43) Pub. Date: May 31, 2018

(54) SYSTEMS AND METHODS FOR PATH PLANNING IN AUTONOMOUS VEHICLES

(71) Applicant: GM GLOBAL TECHNOLOGY OPERATIONS LLC, Detroit, MI (US)

(72) Inventors: DREW GROSS, SAN FRANCISCO, CA (US); GABRIEL WARSHAUER-BAKER, MOUNTAIN VIEW, CA (US); BEN WEINSTEIN-RAUN, SAN FRANCISCO, CA (US); ERIC LUJAN, SAN FRANCISCO, CA (US)

(73) Assignee: GM GLOBAL TECHNOLOGY OPERATIONS LLC, Detroit, MI (US)

(21) Appl. No.: 15/878,646

(22) Filed: Jan. 24, 2018

(51) Int. Cl. G05D 1/02; G05D 1/00

(52) U.S. Cl. CPC G05D 1/0221; G05D 1/0088

(57) ABSTRACT

Systems and method are provided for controlling a vehicle. In one embodiment, a method includes defining a region of interest and an intended path of the vehicle based on sensor data, and determining a set of predicted paths of one or more objects likely to intersect the region of interest within a planning horizon. The method further includes defining, within a spatiotemporal path space associated with the region of interest and the planning horizon, a set of obstacle regions corresponding to the set of predicted paths. Decision points for each of the obstacle regions are determined, and a directed graph is defined based on the plurality of decision points and a cost function applied to a set of path segments interconnecting the decision points. The directed graph is then searched to determine a selected path.

### TECHNICAL FIELD

The present disclosure generally relates to autonomous vehicles, and more particularly relates to systems and methods for path planning in an autonomous vehicle.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While recent years have seen significant advancements in autonomous vehicles, such vehicles might still be improved in a number of respects. For example, it is often difficult for an autonomous vehicle to quickly determine a suitable path (along with target accelerations and velocities) to maneuver through a region of interest while avoiding obstacles whose paths might intersect with the region of interest within some predetermined planning horizon. Such scenarios arise, for example, while taking an unprotected left turn, maneuvering around a double-parked car, merging into oncoming traffic, and the like.

Accordingly, it is desirable to provide systems and methods for path planning in autonomous vehicles. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a first vehicle. In one embodiment, a method of path planning includes receiving sensor data relating to an environment associated with a vehicle, defining a region of interest and an intended path of the vehicle based on the sensor data, and determining a set of predicted paths of one or more objects likely to intersect the region of interest within a planning horizon. The method further includes defining, within a spatiotemporal path space associated with the region of interest and the planning horizon, a set of obstacle regions corresponding to the set of predicted paths, and defining a plurality of decision points for each of the obstacle regions. The method further includes defining a directed graph based on the plurality of decision points and a cost function applied to a set of path segments interconnecting the decision points, and performing, with a processor, a search of the directed graph to determine a selected path.

In one embodiment, defining the directed graph includes providing a directed edge between a first decision point to a second decision point if: the second decision point is subsequent in time to the first vertex; the second decision point corresponds to a greater distance than the first decision point; the directed edge would not pass through one of the obstacle regions; and the directed edge would not exceed a kinematic constraint associated with the vehicle.

In one embodiment, the cost function is based on at least one of occupant comfort, energy usage, and a distance between the vehicle and the objects.

In one embodiment, each obstacle region of the set of obstacle regions is a polygon and the decision points are located at vertices of the polygon.

In one embodiment, each obstacle region of the set of obstacle regions is a rectangle.

In one embodiment, the decision points associated with each obstacle region are located at opposite corners of the rectangle, and one of the corners corresponds to a point on the obstacle region corresponding to a minimum time along the intended path and a minimum distance along the intended path.

In one embodiment, the region of interest is associated with one of an unprotected left turn by the vehicle, entry of a traffic flow by the vehicle, or maneuvering around a double-parked vehicle by the vehicle.

A system for controlling a vehicle in accordance with one embodiment includes a region of interest determination module, an object path determination module, a path space determination module, and a graph definition and analysis module. The region of interest determination module configured to receive sensor data relating to an environment associated with a vehicle, and define a region of interest and an intended path of the vehicle based on the sensor data. The object path determination module configured to determine a set of predicted paths of one or more objects likely to intersect the region of interest within a planning horizon. The path space definition module configured to define, within a spatiotemporal path space associated with the region of interest and the planning horizon, a set of obstacle regions corresponding to the set of predicted paths, and define a plurality of decision points for each of the obstacle regions. The graph definition and analysis module configured to define a directed graph based on the plurality of decision points and a cost function applied to a set of path segments interconnecting the decision points, and perform, with a processor, a search of the directed graph to determine a selected path.

In one embodiment, the graph definition and analysis module defines the directed graph by providing a directed edge between a first decision point to a second decision point if: the second decision point is subsequent in time to the first vertex; the second decision point corresponds to a greater distance than the first decision point; the directed edge would not pass through one of the obstacle regions; and the directed edge would not exceed a kinematic constraint associated with the vehicle.

In one embodiment, the cost function is based on at least one of occupant comfort, energy usage, and a distance between the vehicle and the objects.

In one embodiment, each obstacle region of the set of obstacle regions is a polygon and the decision points are located at vertices of the polygon.

In one embodiment, each obstacle region of the set of obstacle regions is a rectangle.

In one embodiment, the decision points associated with each obstacle region are located at opposite corners of the rectangle, and one of the corners corresponds to a point on the obstacle region corresponding to a minimum time along the intended path and a minimum distance along the intended path.

In one embodiment, the region of interest is associated with one of an unprotected left turn by the vehicle, entry of a traffic flow by the vehicle, or maneuvering around a double-parked vehicle by the vehicle.

An autonomous vehicle in accordance with one embodiment includes at least one sensor that provides sensor data, and a controller that, by a processor and based on the sensor data defines a region of interest and an intended path of the autonomous vehicle based on the sensor data, and determines a set of predicted paths of one or more objects likely to intersect the region of interest within a planning horizon. The processor further defines, within a spatiotemporal path space associated with the region of interest and the planning horizon, a set of obstacle regions corresponding to the set of predicted paths; defines a plurality of decision points for each of the obstacle regions; defines a directed graph based on the plurality of decision points and a cost function applied to a set of path segments interconnecting the decision points; and performs, with a processor, a search of the directed graph to determine a selected path.

In one embodiment, the controller defines the directed graph by providing a directed edge between a first decision point to a second decision point if: the second decision point is subsequent in time to the first vertex; the second decision point corresponds to a greater distance than the first decision point; the directed edge would not pass through one of the obstacle regions; and the directed edge would not exceed a kinematic constraint associated with the vehicle.

In one embodiment, the cost function is based on at least one of occupant comfort, energy usage, and a distance between the vehicle and the objects.

In one embodiment, each obstacle region of the set of obstacle regions is a rectangle and the decision points are located at vertices of the rectangle.

In one embodiment, the decision points associated with each obstacle region are located at opposite corners of the rectangle, and one of the corners corresponds to a point on the obstacle region corresponding to a minimum time along the intended path and a minimum distance along the intended path.

In one embodiment, the region of interest is associated with one of an unprotected left turn by the vehicle, entry of a traffic flow by the vehicle, or maneuvering around a double-parked vehicle by the vehicle.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle including a path planning system, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a dataflow diagram illustrating a path planning system of an autonomous vehicle, in accordance with various embodiments;

FIG. 5 is a flowchart illustrating a control method for controlling the autonomous vehicle, in accordance with various embodiments;

FIG. 6 is a top-down view of an intersection useful in understanding systems and methods in accordance with various embodiments;

FIG. 7 illustrates a region of interest corresponding to the intersection illustrated in FIG. 6, in accordance with various embodiments;

FIG. 8 presents a path planning visualization corresponding to the region of interest of FIG. 7, in accordance with various embodiments;

FIG. 9 depicts the path-planning visualization of FIG. 8 including obstacle regions, in accordance with various embodiments;

FIG. 10 depicts the path-planning visualization of FIG. 9 including decision points, in accordance with various embodiments;

FIG. 11 illustrates a directed graph corresponding to the decision points of FIG. 10, in accordance with various embodiments;

FIG. 12 depicts another example path-planning visualization, in accordance with various embodiments;

FIG. 13 illustrates a directed graph corresponding to the decision points of FIG. 12, in accordance with various embodiments; and

FIGS. 14 and 15 present additional scenarios and regions of interests, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

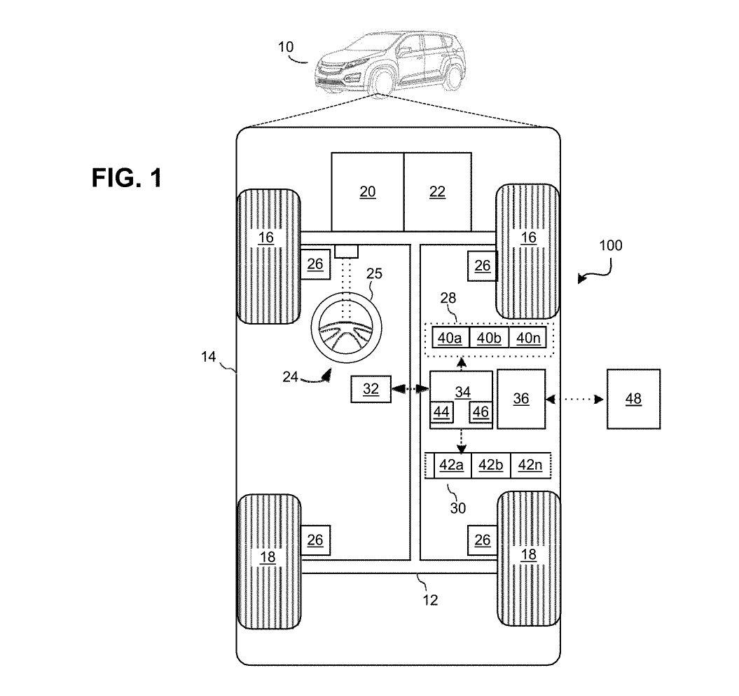

With reference to FIG. 1, a path planning system shown generally as 100 is associated with a vehicle (or “AV”) 10 in accordance with various embodiments. In general, path planning system (or simply “system”) 100 allows for selecting a path for AV 10 by determining the predicted paths of objects likely to intersect a region of interest, then generating and searching within a directed graph corresponding to decision points associated with obstacle regions that are defined within a spatiotemporal path space.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the path planning system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any vehicle in which the present subject matter may be implemented, regardless of its level of autonomy.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10 (such as the state of one or more occupants). Sensing devices 40a-40n might include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

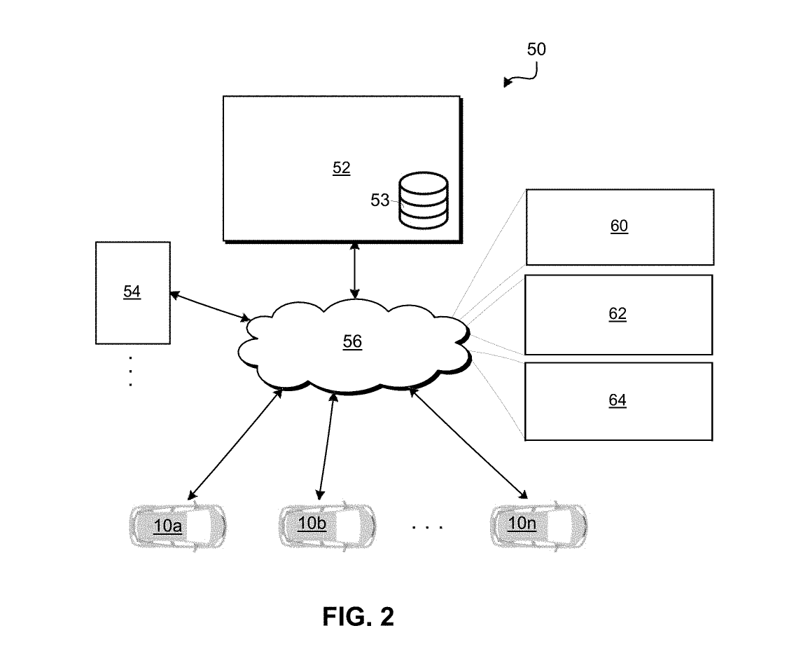

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, controller 34 is configured to implement a path planning system as discussed in detail below.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous-vehicle-based remote transportation system. FIG. 2 illustrates an exemplary embodiment of an operating environment shown generally at 50 that includes an autonomous-vehicle-based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

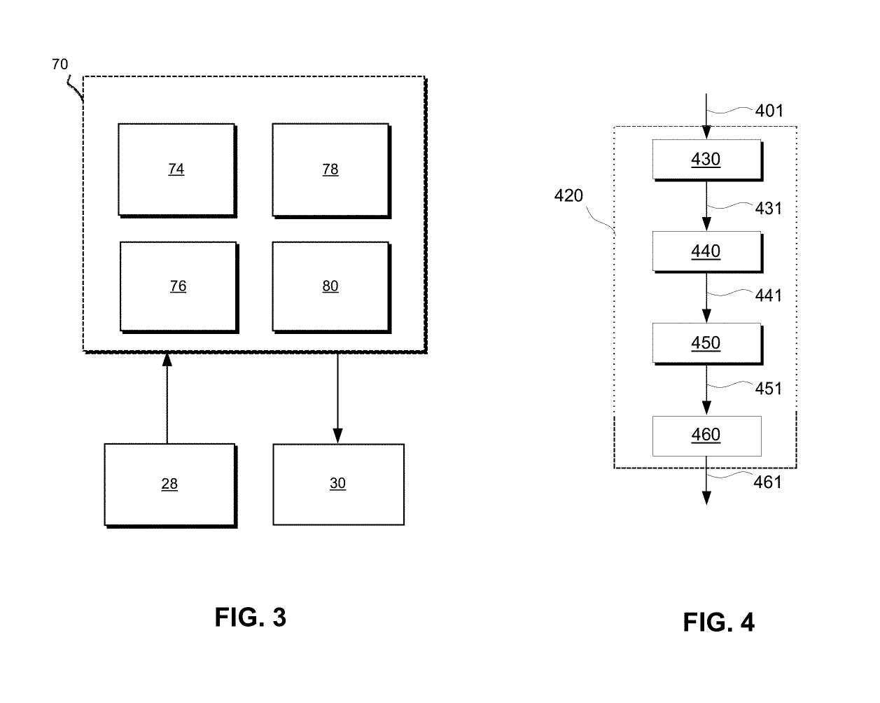

In accordance with various embodiments, controller 34 implements an autonomous driving system (ADS) 70 as shown in FIG. 3. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors (e.g., sensor system 28), including but not limited to cameras, lidars, radars, and/or any number of other types of sensors.

The positioning system 76 processes sensor data along with other data to determine a position (e.g., a local position relative to a map, an exact position relative to a lane of a road, a vehicle heading, etc.) of the vehicle 10 relative to the environment. As can be appreciated, a variety of techniques may be employed to accomplish this localization, including, for example, simultaneous localization and mapping (SLAM), particle filters, Kalman filters, Bayesian filters, and the like.

The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

It will be understood that various embodiments of the path planning system 100 according to the present disclosure may include any number of sub-modules embedded within the controller 34 which may be combined and/or further partitioned to similarly implement systems and methods described herein. Furthermore, inputs to the path planning system 100 may be received from the sensor system 28, received from other control modules (not shown) associated with the autonomous vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

In various embodiments, all or parts of the path planning system 100 may be included within the computer vision system 74, the positioning system 76, the guidance system 78, and/or the vehicle control system 80. As mentioned briefly above, the path planning system 100 of FIG. 1 is configured to select a path for AV 10 by determining the predicted paths of objects likely to intersect a region of interest (e.g., a lane through which AV 10 must travel to merge with traffic), then generating and searching within a directed graph corresponding to decision points associated with obstacle regions that are defined within a spatiotemporal path space.

Referring to FIG. 4, an exemplary path planning system generally includes a spatiotemporal decision-point solver module (or simply “solver module”) 420 that takes as its input sensor data 401 (e.g., optical camera data, lidar data, radar data, etc.) and produces an output 461 specifying a selected path that takes AV 10 through a region of interest while avoiding moving objects (e.g., other vehicles) whose paths might intersection the region of interest during some predetermined time interval, e.g., a “planning horizon.”

In accordance with various embodiments, solver module 420 itself includes a region of interest determination module 430, an object path determination module 440, a path space definition module 450, and a graph definition and analysis module 460.

Module 430 is generally configured to define or assist in defining a region of interest and an intended path of the vehicle based on the sensor data 401. Module 440 is generally configured to determine a set of predicted paths of one or more objects likely to intersect the region of interest within a planning horizon (e.g., a predetermined length of time). Module 450 is generally configured to define, within a spatiotemporal path space associated with the region of interest and the planning horizon, a set of obstacle regions corresponding to the set of predicted paths and a plurality of decision points for each of the obstacle regions. Module 460 is generally configured to construct a directed graph based on the plurality of decision points and a cost function applied to a set of path segments interconnecting the decision points, and then search the directed graph to determine a selected path 461 that substantially minimizes the cost function.

Output 421 might take a variety of forms, but will generally specify, as a function of time, a path in terms of positions, velocities, and accelerations of the type that might typically be produced by guidance system 78 of FIG. 3. That is, the term “path” as used in connection with the actions of AV 10 will generally include, in addition to positional information as a function of time, a series of planned accelerations, braking events, and the like that will accomplish the intended maneuver. For reasons that will be discussed below, spatiotemporal decision-point solver module 420 may also be referred to herein by the shorthand phrase “trumpet solver module.”

One or more of the modules described above (e.g., modules 420, 430, 440, 450, and 460) may be implemented as one or more machine learning models that undergo supervised, unsupervised, semi-supervised, or reinforcement learning and perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models. In some embodiments, training of any models incorporated into module 420 may take place within a system remote from vehicle 10 (e.g., system 52 in FIG. 2) and subsequently downloaded to vehicle 10 for use during normal operation of vehicle 10. In other embodiments, training occurs at least in part within controller 34 of vehicle 10, itself, and the model is subsequently shared with external systems and/or other vehicles in a fleet (such as depicted in FIG. 2).

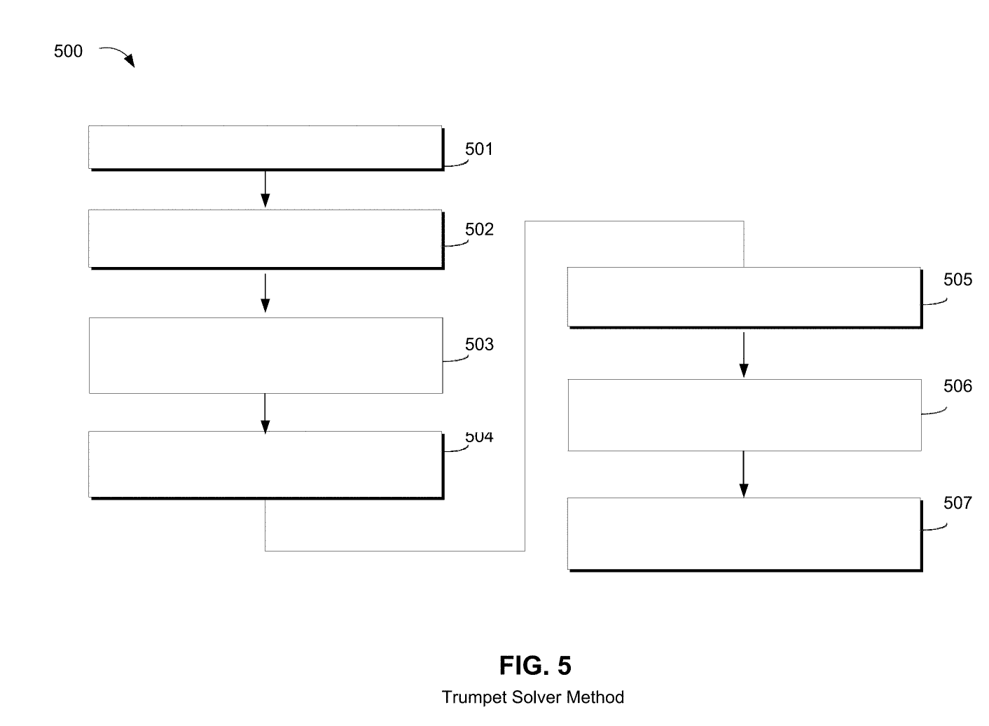

Referring now to FIG. 5, and with continued reference to FIGS. 1-4, the illustrated flowchart provides a control method 500 that can be performed by path planning system 100 (e.g., module 420) in accordance with the present disclosure. As can be appreciated in light of the disclosure, the order of operation within the method is not limited to the sequential execution as illustrated in the figure, but may be performed in one or more varying orders as applicable and in accordance with the present disclosure. In various embodiments, the method can be scheduled to run based on one or more predetermined events, and/or can run continuously during operation of autonomous vehicle 10.

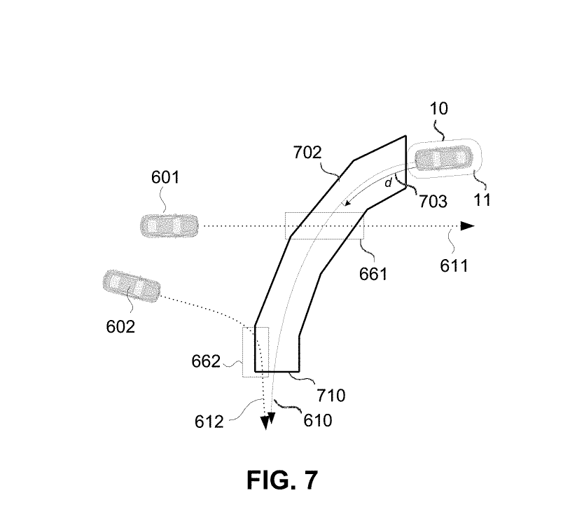

In various embodiments, the method begins at 501, in which a “region of interest” and intended path of AV 10 are determined. In general, the phrase “region of interest” refers to any closed spatial region (e.g., roadway, intersection, etc.) through which AV 10 intends to traverse in the near term (e.g., within some predetermined time interval or “planning horizon”). This region may be determined, for example, by guidance system 78 of FIG. 3 in conjunction with module 430, and may be specified in a variety of ways. For example, the region of interest may be defined as a polygon, a curvilinear closed curve, or any other closed shape. In some embodiments, the “width” of the region of interest (i.e., in a direction perpendicular to the intended movement of AV 10 within the region of interest) is equal to the width of AV plus some predetermined margin or buffer distance (e.g., buffer 11 in FIG. 7). It will be understood that the nature of the region of interest and intended path will vary depending upon the context and the maneuver planned for AV 10 (e.g., unprotected left turn, merging with traffic, entering oncoming traffic, maneuvering around a double-parked car, passing a slow car on its left, etc.).

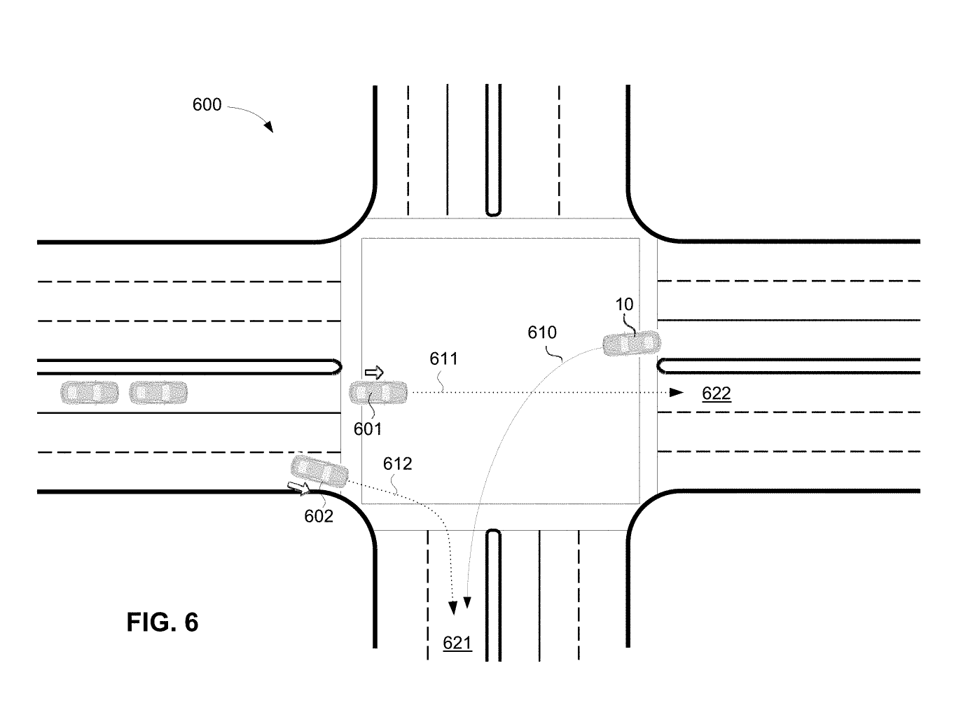

FIG. 6 depicts an example scenario helpful in understanding the present subject matter. As shown, AV 10 has an intended path 610 corresponding to an unprotected left turn into a lane 621 at an intersection 600. Also shown in FIG. 6 are a number of vehicles (or “obstacles”) that might be relevant in deciding whether and/or how AV 10 should complete its turn, as well as its target and acceleration and velocity during that turn. For example, AV 10 may observe an oncoming vehicle 601 whose trajectory indicates that it intends to cross intersection 600 and continue on in lane 622, and another vehicle 602 whose trajectory indicates that it intends to make a right turn into the same lane 621 being targeted by AV 10. The region of interest in this scenario is the area (or lane) that AV 10 will likely traverse in following path 610. In that regard, FIG. 7 depicts a simplified version of FIG. 6 that isolates certain features of the illustrated scenario, namely, a region of interest 702 corresponding to intended path 703 of AV 10 as it takes a left turn, as well as paths 611 and 612 of vehicles 601 and 602, respectively. As mentioned above, while region of interest 702 in FIG. 7 is illustrated as a polygon, the present embodiments are not limited to such representations.

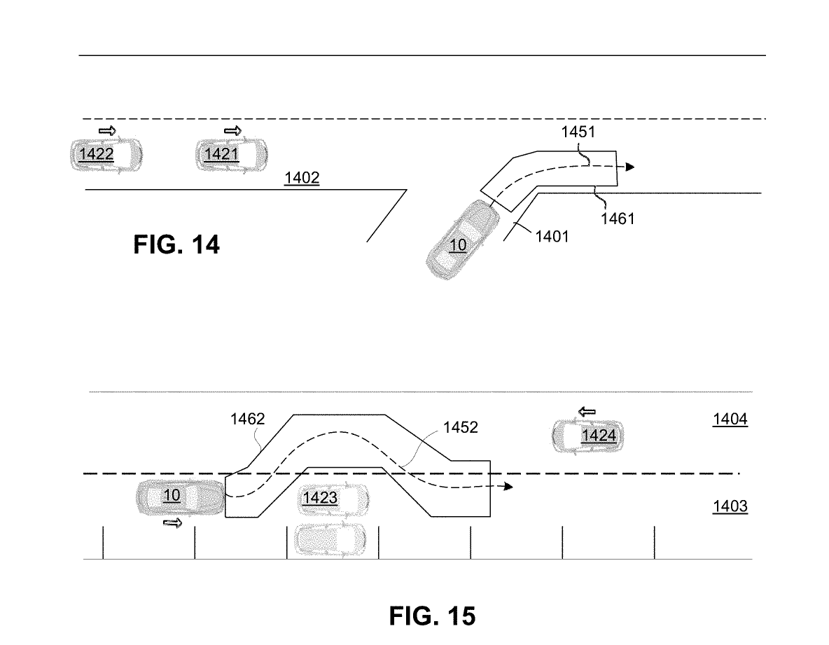

Furthermore, it will be appreciated that the present systems and methods are not limited to unprotected left turn scenarios as depicted in FIG. 6, and may be employed in any context in which AV 10 has an intended path within a region of interest that requires consideration of moving objects (e.g., other vehicles) in the vicinity. Referring momentarily to FIG. 14, for example, systems in accordance with various embodiments may be used in cases in which AV 10 has an intended path 1451 through a region of interest 1461 when attempting to enter lane 1402 from a lane 1401, taking into account oncoming vehicles 1421 and 1422. FIG. 15 shows another example, in which AV 10 has an intended path 1452 that takes it through a region of interest 1462 around a double-parked vehicle 1423, taking into account oncoming vehicle 1424. As shown, path 1452 takes AV 10 from lane 1403, to lane 1404, and back to lane 1403.

Referring again to FIG. 5, the predicted paths of objects (or “obstacles”) likely to intersect the region of interest (and tracked by AV 10 using sensor system 28) are determined (e.g., via module 440) within some predetermined time interval or “planning horizon” (502). This determination may take into account, for example the position, speed, acceleration, pose, size, and any other relevant attribute of nearby objects, as well as the position, size, and geometry of the region of interest and the planning horizon.

Computer vision system 74 of FIG. 3 may be employed to determine which objects, if any, are likely to intersect with the region of interest within the planning horizon. In this regard, the planning horizon time interval may vary depending upon a number of factors, but in one embodiment is between approximately 10-20 seconds, such as 15 seconds. The range of possible embodiments is not so limited, however. Referring again to the example depicted in FIG. 7, it can be seen that paths 611 and 612 intersect (at 661 and 662, respectively) the region of interest 702.

Once the region of interest and possible obstacles are determined, a spatiotemporal path space is then defined by module 450 (at 503) based on the planning horizon and the region of interest. In accordance with one embodiment, the spatiotemporal path space is a planar Cartesian space (R²) in which one axis corresponds to the future travel distance (d) along the intended path of AV, and another axis corresponds to time (t).

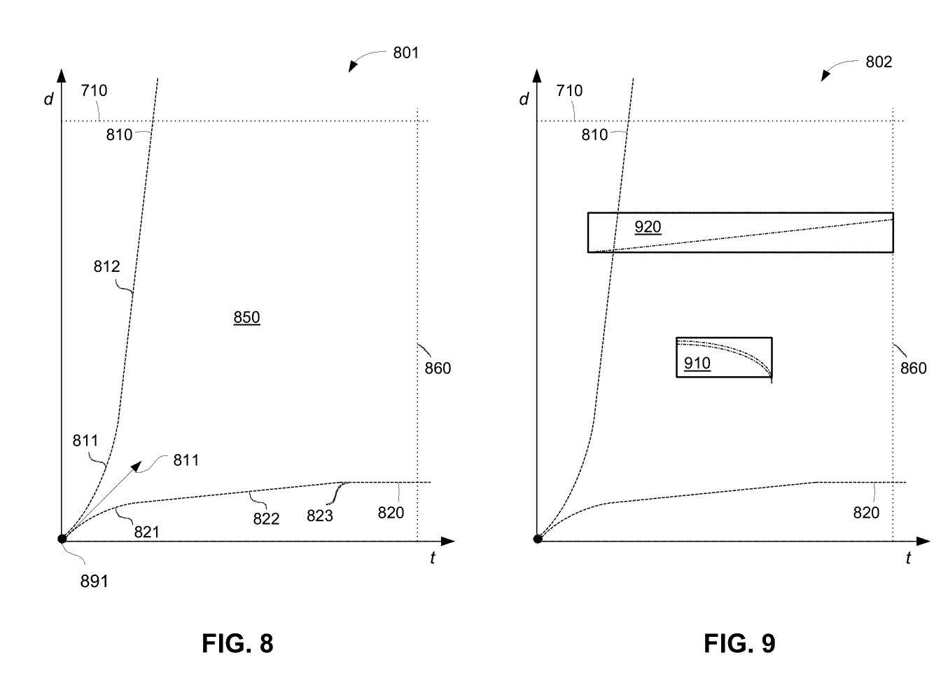

FIG. 8 presents a path planning visualization (or simply “visualization”) 801 illustrating a spatiotemporal path space (or simply “space”) 850 representing a region in which possible path segments (for AV 10 of FIG. 7) may be defined, as described in further detail below. It will be appreciated that visualization 801 (as well as the visualizations that follow) will generally not be literally displayed or graphically represented by system 100. That is, these visualizations are provided in order to provide an intuitive understanding of how system 100 may operate in accordance with various embodiments.

With continued reference to FIG. 8, space 850 of visualization 801 is bounded on the right by the planning horizon 860 (e.g., a predetermined time interval in which AV 10 is attempting to complete a maneuver) and bounded near the top by a line 710 corresponding to the end or terminus of region of interest 702 (e.g., lane end 710 of FIG. 7). The initial condition of AV 10 (corresponding, for example, to the time and position just prior to AV 10 entering the region of interest) corresponds to point 801 (e.g., d, t=[0,0]), and the vector 811 indicates the initial velocity of AV 10 as it enters the region of interest 702.

Thus, the goal of AV 10 will generally be to reach lane end 710 within the planning horizon (topmost horizontal line in FIG. 8). However, it may be the case that AV 10 cannot do so (e.g., due to the presence of many large obstacles intersecting its path), and will instead reach some other intermediary position at the end of the planning horizon 860 (requiring a subsequent path search to complete its intended path).

It will be appreciated that AV 10 may be subject to a set of kinematic constraints, which will generally vary depending upon the nature of AV 10. Such kinematic constraints (which may be embodied as settings configurable by an operator) might include, for example, maximum acceleration, minimum acceleration, maximum speed, minimum speed, and maximum jerk (i.e., rate of change of acceleration).

In this regard, it will be appreciated that the slope of a curve at any point within visualization 801 corresponds to the instantaneous velocity of an object (e.g., AV 10), and the rate of change of slope corresponds to the instantaneous acceleration of that object. Thus, FIG. 8 illustrates two boundaries leading from initial position 801: a boundary 810 corresponding to a maximum acceleration segment 811 followed by a maximum speed segment 812, and a boundary 820 including a minimum acceleration (or maximum deceleration) segment 821, a minimum speed segment 822, and a “stopped” segment 823. It can be seen that boundaries 810 and 820, as they flare outward together from initial position 801, define a shape that is reminiscent of a trumpet bell, hence the shorthand name “trumpet solver” as used herein.

Referring again to FIG. 5, one or more obstacle regions are defined within the spatiotemporal path space (at 504) by module 450. These obstacle regions are configured to specify the estimated future positions of each of the objects identified at 502 relative to AV 10 with respect to both time and position. Thus, obstacle regions may correspond to both stationary and moving obstacles. Referring to FIG. 9, for example, two obstacle regions have been defined in visualization 802: obstacle region 910 (corresponding to path intersection 661 of vehicle 601 in FIG. 7) and obstacle region 920 (corresponding to path intersection 662 of vehicle 602 in FIG. 7).

While regions 910 and 920 are illustrated as rectangles, the range of embodiments is not so limited. The dashed lines within regions 910 and 920 represent the actual paths likely to be taken by vehicles 601 and 602, respectively. Thus, any convenient polygon or curvilinear shape that encompasses these likely paths may be employed. Rectangles, however, are advantageous in that they can easily be modeled and represented, and can be used to generate decision points as described in further detail below.

Once the obstacle regions (e.g., regions 910 and 920) have been defined, system 100 then defines (at 505) decision points (within the spatiotemporal path space) for one or more of the obstacle regions. As used herein, the term “decision point” means a point on the perimeter of (or within some predetermined distance of) an obstacle region as defined previously at 504. In various embodiments—for example, in which the obstacle regions are polygons—the decision points are defined at one or more vertices. In various embodiments, the decision points are defined at (or near) a point on the obstacle region that is a minimum with respect to time (e.g., the leftmost point in a spatiotemporal space as described above), a maximum with respect to time, a minimum with respect to distance (i.e., the topmost point in a spatiotemporal space as described above), and/or a maximum with respect to distance. That is, the left and right boundaries substantially correspond to the end of the points where vehicles 601 and 602 would likely interfere with AV 10.

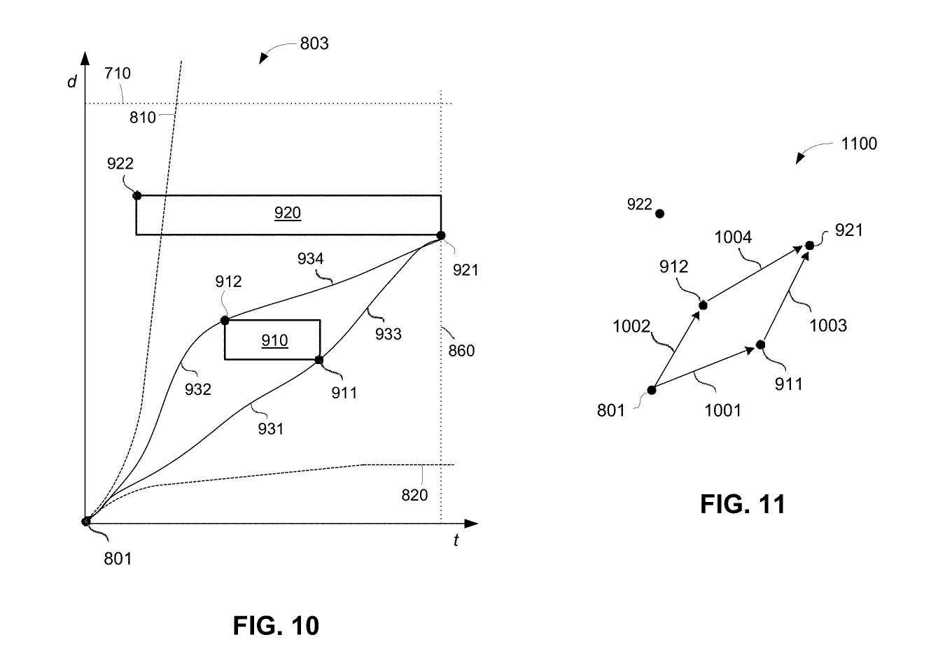

Referring to FIG. 10, for example, two decision points have been defined with respect to each object region. Specifically, decision points 911 and 912 have been defined at opposite corners of object region 910, and decision points 921 and 922 have been defined at opposite corners of object region 920. As shown, decision point 911 is defined at the minimum distance (vertical axis) and maximum time (horizontal axis) of obstacle region 910, while decision point 912 is defined at the maximum distance and minimum time of obstacle region 910.

It will be appreciated that the decision points as shown in visualization 803 of FIG. 10 correspond intuitively to “waypoints” (in terms of position and time) that AV 10 would need to reach to either wait for an object to pass (lower right decision points), or to pass in front of that object (upper left decision points). Thus, decision point 912 corresponds to AV 10 passing in front of vehicle 601, and decision point 911 corresponds to AV 10 waiting for vehicle 601 to pass (e.g., by reducing its speed). It will be appreciated that decision point 922 is unlikely to be reached, since it lies to the left of boundary 810, and would require AV 10 to exceed its kinematic constraints with respect to maximum acceleration and/or maximum speed.

Accordingly, at 506, module 460 defines a graph (e.g., a directed acyclic graph) wherein the vertices of the graph correspond to the decision points (or a subset of the decision points) defined at 505, and the edges of the graph correspond to a particular path segment between the decision points. System 100 further defines a cost value associated with each of the edges, which quantifies the relative desirability of AV following that path segment based on some predetermined cost function.

Referring to FIG. 10, for example, a set of path segments 931-934 are shown. Path segment 932 leads from the initial position 801 to decision point 912, path segment 934 leads from decision point 912 to decision point 921, path segment 931 leads from initial position 801 to decision point 911, and path segment 933 leads from decision point 911 to decision point 921.

FIG. 11 illustrates a directed, acyclic graph corresponding to the visualization 803 of FIG. 10. As shown, graph 1100 includes a set of vertices (or “nodes”) 911, 912, 801, 921, and 922 (corresponding to the equivalent decision points in FIG. 10), and a set of edges 1001, 1002, 1003, and 1004 having the topology shown in FIG. 11. Note that vertex 922 is not connected to the rest of graph 1100. That is, in some embodiments, in the interest of computational complexity, edges are not drawn to or from unreachable vertices.

Referring to the graph of FIG. 11 in conjunction with the visualization of FIG. 10, it will be apparent that AV 10 has two path choices: a first path including path segments 932 and 934, and a second path including path segments 931 and 933. Intuitively, the first path corresponds to AV 10 speeding up slightly to move in front of vehicle 601, then slowing down to let vehicle 602 pass (vertices 801→912→921 in FIG. 11). The second path corresponds to AV 10 staying at approximately the same speed, allowing vehicle 601 to pass, and then speeding up slightly and allowing vehicle 602 to pass (vertices 801→911→921).

In according to various embodiments, a cost function value (or simply “cost”) is assigned to each of the edges of the graph, and a final path is selected to reduce the sum of these costs. For example, referring to FIG. 11, each of the edges 1001-1004 has its own assigned cost, which may be an integer, a real number, or any other quantitative measure that would allow paths to be compared. In various embodiments, cost function produces a number based on various factors. Such factors may include, without limitation: occupant comfort (e.g., lower acceleration and/or jerk), energy usage, distance between AV 10 and obstacles during maneuver (e.g., high cost attached to traveling close to another vehicle), whether and to what extent the end of the region of interest has been reached (i.e., line 710 in FIG. 10), and the like.

In some embodiments, the cost function is configured to penalize not making it through the intersection. In other embodiments, the cost function penalizes sitting still in an intersection. In some embodiments, the graph search terminates when it has found any valid path, or when it has found the best path, or after it has exhausted a fixed budget of search time.

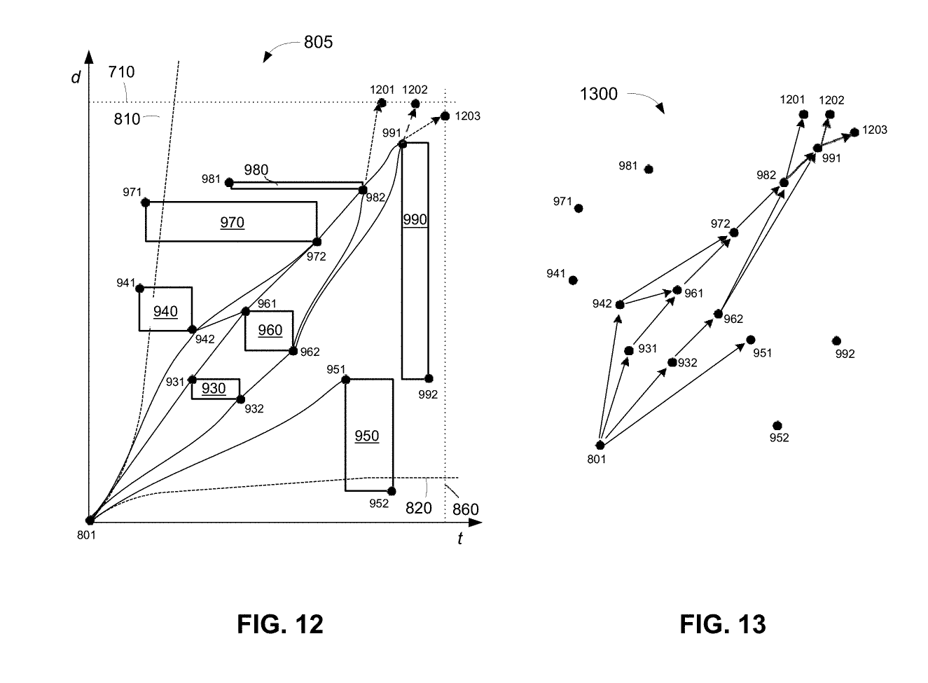

In order to more fully describe the manner in which graphs are constructed based on decision points, FIGS. 12 and 13 present an example visualization 805 and associated graph 1300 in accordance with a more complex scenario in which AV 10 must find a path through seven obstacles of various sizes and speeds. In this example, seven rectangular obstacle regions (930, 940, 950, 960, 970, 980, and 990) have been defined, each corresponding to a different vehicle or other such obstacle. As with the previous example, a pair of decision points have been assigned to each obstacle at that obstacle's upper left and lower right corners. Thus, decision points 931 and 932 are assigned to obstacle region 930, decision points 941 and 942 are assigned to obstacle region 930, decision points 951 and 952 are assigned to obstacle region 950, decision points 961 and 962 are assigned to obstacle region 960, decision points 971 and 972 are assigned to obstacle region 970, decision points 981 and 982 are assigned to obstacle region 980, and decision points 991 and 992 are assigned to obstacle region 990.

In the interest of clarity, the individual path segments have not been separately numbered in FIG. 12, but can be designated by specifying an order set of consecutive decision points, e.g., path {801, 932, 962, 982, 991, 1203}. Note that decision points 941, 971, and 981 are not connected to the rest of graph 1300, as those points are not reachable given the kinematic constraints, as described above.

In order to construct graph 1300, an edge is drawn between a first vertex and a second vertex if an only if (a) the second vertex is subsequent in time to the first vertex, (b) the second vertex has a greater distance d than the first vertex, (c) the resulting edge would not pass through an obstacle region, and (d) the resulting edge would not exceed a kinematic constraint (such as maximum speed). Thus, for example, decision point 962 is connected to both decision points 982 and 991, but is not connected to decision point 972 (which would require reaching an unreachable speed) or decision point 1203 (which would require passing through obstacle region 990).

Note that three “endpoints” are illustrated in FIG. 12—decision points 1201, 1202, and 1203. Decision points 1201 and 1202 correspond to reaching the end of the lane 710 (i.e., finishing the maneuver through the region of interest), and decision point 1203 corresponds to the case of reaching the end of the planning horizon 860 before reaching the end of the lane 710. That is, all of these decision points 1201, 1202, and 1203 are possible desirable endpoints reaching the desired destination. These end points may be selected from all candidate end points lying on lines 710 and 860 in a variety of ways. In one embodiment, for decision points closest to lines 710 and 860, the ending speed of every path segment leading to that decision point is considered and projected until it intersects either line 710 or 860. These intersections are then added as vertices to graph 1300. Thus, for example, it can be seen that an AV 10 proceeding along path segment {962, 982} would, if it maintained the same speed, reach vertex 1201. Similarly, path segment {962, 991} would result in vertex 1202, and path segment {982, 991} would result in vertex 1203.

Referring again to FIG. 5, having thus constructed a graph and assigned costs to its edges, a suitable graph search is performed (at 507) to select a best-case (lowest total cost) path. That is, a sequence of path segments are selected that accomplishes the desired goal of AV 10 (e.g., traveling along its intended path and completing its traversal of the region of interest, or reaching the end of the planning horizon) while minimizing the sum of the costs of the selected path segments. A variety of methods may be used to perform this search. In one embodiment, a Djikstra graph search algorithm is used. In another embodiment, an A* graph search algorithm is used. Regardless of the particular method used to select an optimal or near-optimal path, the result is a selected path corresponding to the output 421 of trumpet solver module 420 in FIG. 4.

For example, referring again to the scenario illustrated in FIGS. 12 and 13, system 100 might determine that the lowest-cost path is described by the ordered set of vertices {801, 923, 991, 1202}. Intuitively, it can be seen that this is a reasonable choice, since the resulting path requires very few changes in velocity and has an endpoint 1202 at the end of the region of interest (i.e., the intended maneuver has been completed). The output 421 of module 420 would then include a set of kinematic values, stored in any convenient data structure, that specifies the sequence of acceleration, velocity, and position values required by AV 10 to accomplish the selected path.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of path planning comprising:
receiving sensor data relating to an environment associated with a vehicle;
defining a region of interest and an intended path of the vehicle based on the sensor data;
determining a set of predicted paths of one or more objects likely to intersect the region of interest within a planning horizon;
defining, within a spatiotemporal path space associated with the region of interest and the planning horizon, a set of obstacle regions corresponding to the set of predicted paths;
defining a plurality of decision points for each of the obstacle regions;
defining a directed graph based on the plurality of decision points and a cost function applied to a set of path segments interconnecting the decision points; and
performing, with a processor, a search of the directed graph to determine a selected path.

2. The method of claim 1, wherein defining the directed graph includes providing a directed edge between a first decision point to a second decision point if: the second decision point is subsequent in time to the first vertex; the second decision point corresponds to a greater distance than the first decision point; the directed edge would not pass through one of the obstacle regions; and the directed edge would not exceed a kinematic constraint associated with the vehicle.

3. The method of claim 1, wherein the cost function is based on at least one of occupant comfort, energy usage, and a distance between the vehicle and the objects.

4. The method of claim 1, wherein each obstacle region of the set of obstacle regions is a polygon and the decision points are located at vertices of the polygon.

5. The method of claim 4, wherein each obstacle region of the set of obstacle regions is a rectangle.

6. The method of claim 5, wherein the decision points associated with each obstacle region are located at opposite corners of the rectangle, and one of the corners corresponds to a point on the obstacle region corresponding to a minimum time along the intended path and a minimum distance along the intended path.

7. The method of claim 1, wherein the region of interest is associated with one of an unprotected left turn by the vehicle, entry of a traffic flow by the vehicle, or maneuvering around a double-parked vehicle by the vehicle.

8. A system for controlling a vehicle, comprising:
a region of interest determination module configured to receive sensor data relating to an environment associated with a vehicle, and define a region of interest and an intended path of the vehicle based on the sensor data;
an object path determination module configured to determine a set of predicted paths of one or more objects likely to intersect the region of interest within a planning horizon;
a path space definition module configured to define, within a spatiotemporal path space associated with the region of interest and the planning horizon, a set of obstacle regions corresponding to the set of predicted paths, and define a plurality of decision points for each of the obstacle regions;
a graph definition and analysis module configured to define a directed graph based on the plurality of decision points and a cost function applied to a set of path segments interconnecting the decision points, and perform, with a processor, a search of the directed graph to determine a selected path.

9. The system of claim 8, wherein the graph definition and analysis module defines the directed graph by providing a directed edge between a first decision point to a second decision point if: the second decision point is subsequent in time to the first vertex; the second decision point corresponds to a greater distance than the first decision point; the directed edge would not pass through one of the obstacle regions; and the directed edge would not exceed a kinematic constraint associated with the vehicle.

10. The system of claim 8, wherein the cost function is based on at least one of occupant comfort, energy usage, and a distance between the vehicle and the objects.

11. The system of claim 8, wherein each obstacle region of the set of obstacle regions is a polygon and the decision points are located at vertices of the polygon.

12. The system of claim 11, wherein each obstacle region of the set of obstacle regions is a rectangle.

13. The system of claim 12, wherein the decision points associated with each obstacle region are located at opposite corners of the rectangle, and one of the corners corresponds to a point on the obstacle region corresponding to a minimum time along the intended path and a minimum distance along the intended path.

14. The system of claim 8, wherein the region of interest is associated with one of an unprotected left turn by the vehicle, entry of a traffic flow by the vehicle, or maneuvering around a double-parked vehicle by the vehicle.

15. An autonomous vehicle, comprising:
at least one sensor that provides sensor data; and
a controller that, by a processor and based on the sensor data:
defines a region of interest and an intended path of the autonomous vehicle based on the sensor data;
determines a set of predicted paths of one or more objects likely to intersect the region of interest within a planning horizon;
defines, within a spatiotemporal path space associated with the region of interest and the planning horizon, a set of obstacle regions corresponding to the set of predicted paths;
defines a plurality of decision points for each of the obstacle regions;
defines a directed graph based on the plurality of decision points and a cost function applied to a set of path segments interconnecting the decision points; and
performs, with a processor, a search of the directed graph to determine a selected path.

16. The autonomous vehicle of claim 15, wherein the controller defines the directed graph by providing a directed edge between a first decision point to a second decision point if: the second decision point is subsequent in time to the first vertex; the second decision point corresponds to a greater distance than the first decision point; the directed edge would not pass through one of the obstacle regions; and the directed edge would not exceed a kinematic constraint associated with the vehicle.

17. The autonomous vehicle of claim 15, wherein the cost function is based on at least one of occupant comfort, energy usage, and a distance between the vehicle and the objects.

18. The autonomous vehicle of claim 15, wherein each obstacle region of the set of obstacle regions is a rectangle and the decision points are located at vertices of the rectangle.

19. The autonomous vehicle of claim 15, wherein the decision points associated with each obstacle region are located at opposite corners of the rectangle, and one of the corners corresponds to a point on the obstacle region corresponding to a minimum time along the intended path and a minimum distance along the intended path.

20. The autonomous vehicle of claim 15, wherein the region of interest is associated with one of an unprotected left turn by the vehicle, entry of a traffic flow by the vehicle, or maneuvering around a double-parked vehicle by the vehicle.
